(19) United States
(12) Patent Application Publication
(10) Pub. No.: US 2017/0015786 A1
(43) Pub. Date: Jan. 19, 2017

(54) MODIFIED POLYAMIDES HAVING ENHANCED FLOWABILITY/MECHANICAL PROPERTIES AND MOLDING COMPOSITIONS COMPRISED THEREOF

(71) Applicant: RHODIA OPERATIONS, AUBERVILLIERS (FR)

(72) Inventors: Cesare GUAITA, TRADATE (IT); Nicolangelo PEDUTO, MILANO (IT); Giuseppe DI SILVESTRO, LENTATE SUL SEVESO (IT)

(73) Assignee: RHODIA OPERATIONS, AUBERVILLIERS (FR)

(21) Appl. No.: 15/277,318

(22) Filed: Sep. 27, 2016

Related U.S. Application Data
(63) Continuation of application No. 12/225,766, filed on May 26, 2009, now abandoned.

(30) Foreign Application Priority Data
Mar. 31, 2006 (FR) 0602784
Dec. 1, 2006 (FR) 0610513

(51) Int. Cl. C08G 69/26; C08K 7/14; C08L 77/06

(52) U.S. Cl. CPC C08G 69/26; C08L 77/06; C08K 7/14

(57) ABSTRACT

The present invention relates to a polyamide and a process for the preparation thereof, and to compositions containing it. It relates more particularly to a polyamide obtained by polymerization of diacid and diamine monomers in the presence of multifunctional and monofunctional compounds capable of forming an amide function by reaction with either an aminated function or an acid function. This polyamide can in particular be used for the preparation of compositions intended, for example, to be moulded.

The present invention relates to a polyamide and to a process of manufacture of the latter and to compositions comprising it. It relates more particularly to a polyamide obtained by polymerization of diacid and diamine monomers in the presence of polyfunctional and monofunctional compounds capable of forming an amide functional group by reaction either with an amine functional group or an acid functional group. This polyamide is of use in particular in the manufacture of compositions intended, for example, to be molded.

Polyamide-based thermoplastic compositions are starting materials capable of being converted by molding, in particular by injection molding, in order to manufacture plastic components.

There are at least three major properties which it is desired to obtain for these polyamide-based compositions, in particular when they are used in these conversion processes.

The first of these properties is based on the fact that these thermoplastic compositions employed have to be characterized, in the molten state, by a flowability or a rheological behavior which is compatible with shaping processes of interest, such as injection molding. This is because these thermoplastic compositions have to be sufficiently fluid when they are molten to be able to be conveyed and handled easily and rapidly in some shaping devices, such as, for example, injection molding.

It is also an aim to enhance the mechanical properties of these compositions. These mechanical properties are in particular the impact strength, the flexural or tensile modulus, the flexural or tensile breaking stress, inter alia. Use is generally made, to this end, of reinforcing fillers, such as glass fibers.

Finally, in the case of components molded from these thermoplastic compositions, a clean and uniform surface appearance is desired. This constraint becomes a problem which is difficult to solve, particularly when a thermoplastic composition with a high load of glass fibers is used, these glass fibers detrimentally affecting the surface appearance of the molded components. The use is known, in order to obtain an acceptable surface appearance, of thermoplastic compositions exhibiting a high flowability. However, this increase in flowability results in a deterioration in the mechanical properties of the articles obtained.

The result is thus that it is difficult to obtain these different properties for the same polyamide-based thermoplastic composition.

The Applicant Company has developed a polyamide modified by polyfunctional and monofunctional compounds which exhibits an increased flowability and equivalent or superior mechanical properties, in comparison with conventional linear polyamides, and which makes possible the preparation of articles having an excellent surface appearance, in particular when they comprise a high level of fillers.

Such a polyamide is obtained by polymerization of dicarboxylic acid and diamine monomers, of a polyfunctional compound exhibiting at least 3 acid or amine functional groups capable of forming an amide bond with the functional groups of said dicarboxylic acid and diamine monomers, and of a monofunctional compound exhibiting an acid or amine functional group, of the same nature as the functional groups of said polyfunctional compound, capable of forming an amide functional group with the functional groups of said dicarboxylic acid and diamine monomers. The polymerization process is conventional and corresponds to that normally used for polyamide polymerization based on diacid and diamine monomers, such as polyamide 66.

A first subject matter of the present invention is a polyamide capable of being obtained by polymerization in the presence of at least:

(i) dicarboxylic acid and diamine monomers, or their salts,

(ii) from 0.05 to 0.5 mol % of a polyfunctional compound comprising at least 3 functional groups X1, with respect to the number of moles of constituent monomers of the polyamide;

(iii) from 0.2 to 2 mol % of a monofunctional compound comprising a functional group X2, with respect to the number of moles of constituent monomers of the polyamide;

the functional groups X1 and X2 being carboxylic acid functional groups or amine functional groups capable of reacting with the dicarboxylic acid and diamine monomers (i) and of forming an amide bond;
when the polyfunctional compound (ii) comprises functional groups X1 of carboxylic acid type, the monofunctional compound (iii) comprises a functional group X2 of carboxylic acid type; and
when the polyfunctional compound (ii) comprises functional groups X1 of amine type, the monofunctional compound (iii) comprises a functional group X2 of amine type.

The term “number of moles of constituent monomers of the polyamide” is understood to mean the number of moles of dicarboxylic acids added to the number of moles of diamines, it being optionally possible for the latter to be combined in the form of salts, to which is optionally added the number of moles of amino acids or lactams.

The polyfunctional compounds (ii) and the monofunctional compounds (iii) thus relate to functional groups X1 and X2 of the same nature; of carboxylic acid type or of amine type. Preferably, the functional groups X1 of the polyfunctional compounds (ii) and the functional group X2 of the monofunctional compounds (iii) are identical.

Preferably, the polyamide according to the invention is obtained by polymerization of the dicarboxylic acid and diamine monomers, or their salts, a single type of polyfunctional compound. (ii) and a single type of monofunctional compound (iii).

The dicarboxylic acid and diamine monomers are in particular those conventionally used for the manufacture:
of aliphatic polyamides of PA 6.6, PA 6.10, PA 6.12, PA 12.12 or PA 4.6 type,
of semiaromatic polyamides, such as poly(m-xylylenediamine adipate) (MXD6), polyterephthalamides, such as polyamide 6.T and 6.6.6T, polyisophthalamides, such as polyamide 6.1 and 6.6.61,
polyaramides,
or their copolymers.

These dicarboxylic acid and/or diamine monomers can be aliphatic, in particular comprising a linear, branched or cyclic chain, or aromatic.

Mention may in particular be made, as dicarboxylic acid monomer, of aliphatic or aromatic dicarboxylic acids having from 4 to 12 carbon atoms, such as adipic acid, terephthalic acid, isophthalic acid, oxalic acid, malonic acid, succinic acid, glutaric acid, pimelic acid, decanedioic acid or dodecanedioic acid.

Mention may in particular be made, as diamine monomer, of aliphatic, optionally cycloaliphatic, or aromatic diamines having from 4 to 12 carbon atoms, such as hexamethylenediamine, butanediamine, m-xylylenediamine, isophoronediamine, 3,3′,5-trimethylhexamethylenediamine and methylpentamethylenediamine.

It is preferable in particular to use, according to the present invention, the constituent monomers of polyamide 66, which are adipic acid, hexamethylenediamine, or their salts, such as hexamethylenediammonium adipate, optionally known as Nylon salt or N salt.

In the process according to the invention, it is perfectly possible to use an equimolar amount of dicarboxylic acid and of diamine, or alternatively an excess of one of these compounds in order to obtain an imbalance in acid or amine end groups, as is well known to a person skilled in the art.

The modified polyamide according to the invention can comprise one or more dicarboxylic acids and one or more diamines, of different types. Thus, it is possible to add, for example in polymerization, an equimolar amount of dicarboxylic acid and of diamine and a certain proportion of another dicarboxylic acid of another type.

It is also possible to add, to the dicarboxylic acid and diamine monomers, amino acids or their lactams, such as caprolactam, for example. It is possible in particular to add, to the reaction medium, from 1 to 15 mol % of amino acids or lactams, with respect to the number of moles of constituent monomers of the polyamide, preferably from 2 to 10 mol %.

The polyfunctional compound (ii) according to the invention comprises at least 3, preferably between 3 and 10, more preferably 3 or 4, functional groups X1; X1 being a carboxylic acid functional group or an amine functional group capable of reacting with the constituent monomers of the polyamide and of forming an amide bond.

The functional group X1 is preferably a carboxylic acid functional group or a primary or secondary amine functional group, of their salts.

Examples of polyfunctional compounds which may be suitable are mentioned in particular in U.S. Pat. No. 5,346,984, U.S. Pat. No. 5,959,069, WO 96/35739 and EP 672 703.

Preference is given in particular to a polyfunctional compound (ii) of general formula (1):

R-[A-X1]ₙ (1)

in which:
R is an aliphatic (linear or branched), cycloaliphatic or aromatic hydrocarbon radical, comprising at least 2 carbon atoms and which can comprise one or more heteroatoms;
A is a covalent bond or an aliphatic hydrocarbon radical which can comprise one or more heteroatoms, and which comprises from 1 to 20 carbon atoms, preferably from 1 to 6 carbon atoms;
X1 is a carboxylic acid functional group or a primary or secondary amine functional group, or their salts; and
n is an integer between 3 and 10, preferably equal to 3 or 4.

This polyfunctional compound (ii) is preferably an aliphatic (linear or branched), cycloaliphatic or aromatic hydrocarbon compound comprising at least 4 carbon atoms, particularly at least 5 carbon atoms, in particular from 10 to 100 carbon atoms, which can comprise one or more heteroatoms.

The heteroatoms can be O, S, N or P.

A can be a methylene or polymethylene radical, such as the ethyl, propyl or butyl radicals, or a polyoxyalkylene radical, such as the polyoxyethylene radical.

R can be a saturated or unsaturated and linear or branched aliphatic hydrocarbon chain comprising from 2 to 10 carbon atoms which can comprise a cyclohexyl, a cyclohexanoyl, a benzyl, a naphthyl, an anthracenyl, a biphenyl, a triphenyl, a pyridine, a bipyridine, a pyrrole, an indole, a furan, a thiophene, a purine, a quinoline, a phenanthrene, a porphyrin, a phthalocyanin, a naphthalocyanin, a 1,3,5-triazine, a 1,4-diazine, a 2,3,5,6-tetraethylpiperazine, a piperazine or a tetrathiafulvalene.

Mention may in particular be made, as example of polyfunctional compounds (ii) carrying carboxylic acid functional groups X1, of 2,2,6,6-tetra(β-carboxyethyl)cyclohexanone, diaminopropane-N,N,N′,N′-tetraacetic acid, 3,5,3′,5′-biphenyltetracarboxylic acid, acids derived from phthalocyanin and naphthalocyanin, 1,3,5,7-naphthalenetetracarboxylic acid, 2,4,6-pyridinetricarboxylic acid, 3,5,3′,5′-bipyridyltetracarboxylic acid, 3,5,3′,5′-benzophenonetetracarboxylic acid, 1,3,6,8-acridine-tetracarboxylic acid, trimesic acid, 1,2,4,5-benzenetetracarboxylic acid and 2,4,6-tri(aminocaproic acid)-1,3,5-triazine (TACT).

Mention may be made, as example of polyfunctional compounds (ii) carrying amine functional groups X1, of nitrilotrialkylamines, in particular nitrotriethylamine, dialkylenetriamines, in particular diethylenetriamine, bishexamethylenetriamine, trialkylenetetramines and tetraalkylenepentamines, the alkylene preferably being ethylene, 4-aminoethyl-1,8-octanediamine, melamine, compounds originating from the reaction of trimethylolpropane or of glycerol with propylene oxide and amination of the end hydroxyl groups (Jeffamine T® from Huntsman) of general formula:

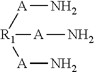

in which: R₁ represents a propane-1,11-triyl or propane-1,2,3-triyl radical and A represents a polyoxyethylene radical.

Use may, for example, be made of Jeffamine T403® (polyoxypropylenetriamine) from Huntsman as polyfunctional compound according to the invention.

The monofunctional compound (iii) is preferably an aliphatic, cycloaliphatic or aromatic hydrocarbon compound comprising at least 2 carbon atoms and which can comprise heteroatoms (O, S, N or P).

The monofunctional compound (iii) is preferably chosen from the group consisting of: n-hexadecylamine, n-octadecylamine and n-dodecylamine, acetic acid, lauric acid, benzylamine, benzoic acid, propionic acid and 4-amino-2,2,6,6-tetramethylpiperidine.

The polymerization of the process of the invention is carried out in particular according to the conventional operating conditions for the polymerization of dicarboxylic acids and diamines, when the polymerization is carried out in the absence of the polyfunctional and monofunctional compounds.

Such a polymerization process can comprise, briefly:
heating the mixture of the monomers, polyfunctional compounds (ii) and monofunctional compounds (iii) with stirring and under pressure,
maintaining the mixture under pressure and temperature for a predetermined period of time and then releasing the pressure and maintaining for a predetermined period of time at a temperature greater than the melting point of the mixture, in particular under nitrogen or under vacuum, in order thus to continue the polymerization by removal of the water formed.

The polyfunctional compounds (ii) and monofunctional compounds (iii) are preferably added at the beginning of the polymerization. In this case, the mixture of the dicarboxylic acid and diamine monomers and of the polyfunctional compounds (ii) and monofunctional compounds (iii) is polymerized.

On exiting from the polymerization, the polymer can be cooled, advantageously with water, and extruded and then cut up in order to produce granules.

The polymerization process according to the invention can certainly be carried out continuously or batchwise.

In the polymerization process of the invention, use is made of 0.05 to 0.5 mol %, preferably of 0.2 to 0.5 mol %, more preferably of 0.25 to 0.4 mol %, of polyfunctional compounds (ii), with respect to the sum of the number of moles of constituent monomers of the polyamide, in particular 0.25, 0.5, 0.1, 0.15, 0.2, 0.25, 0.3, 0.35 and 0.4 mol %.

In the polymerization process of the invention, use is made of 0.2 to 2 mol %, preferably 0.5 to 2 mol %, more preferably of 0.5 to 1 mol %, of monofunctional compounds (iii), with respect to the sum of the number of moles of constituent monomers of the polyamide, in particular 0.4, 0.5, 0.6, 0.7, 0.8 and 0.9 mol %.

Use is preferably made of a proportion of polyfunctional compounds (ii) and monofunctional compounds (iii) which obeys the following relationship:

(nCpo×FX1)/nCmo of between 0.1 and 4,

with:

nCpo the number of moles of polyfunctional compounds (ii),

nCmo the number of moles of monofunctional compounds (iii), and

FX1 the number of functional groups X1 of the polyfunctional compound (ii).

According to the invention, the modified polyamide preferably exhibits a viscosity index in solution of between 80 and 120, according to standard ISO 307 (with 0.5% of polymer in solution in 90% of formic acid, at a temperature of 25° C.), in particular between 85 and 110.

Another subject matter of the present invention is a composition comprising at least the polyamide as defined above.

Preferably, the polyamide of the invention is used as matrix in this composition, in particular in order to produce molded articles.

It may be advantageous, in order to improve the mechanical properties of this composition, to add to it at least one reinforcing and/or bulking filler preferably chosen from the group consisting of fibrous fillers, such as glass fibers, inorganic fillers, such as clays, kaolin or reinforcing or thermosetting nanoparticles, and fillers in the form of powder, such as talc. The degree of incorporation of reinforcing and/or bulking filler is in accordance with the standards in the field of composite materials. It can, for example, be a degree of filler of 1 to 80%, preferably of 10 to 70%, in particular between 30 and 60%.

In addition to the modified polyamide of the invention, the composition can comprise one or more other polymers, preferably polyamides or copolyamides.

The composition according to the invention can additionally comprise additives conventionally used in the manufacture of polyamide compositions intended to be molded. Thus, mention may be made of lubricants, flame retardants, plasticizers, nucleating agents, catalysts, agents for improving the impact strength, such as optionally grafted elastomers, light and/or heat stabilizers, antioxidants, antistatics, colorants, mattifying agents, molding aids or other conventional additives.

These fillers and additives can be added to the modified polyamide by standard means suited to each filler or additive, such as, for example, during melt blending or polymerization.

The polyamide according to the invention can also be used as matrix in a composition comprising a high proportion of additives of masterbatch type intended to be blended with another thermoplastic composition.

The polyamide according to the invention can also be used, as additive or as blend, in particular in order to confer certain properties, in particular rheological properties, in compositions comprising a thermoplastic polymer, in particular a (co)polyamide, as matrix. The polyamide according to the invention is then generally melt-blended with thermoplastic polymers. Use may in particular be made of a proportion of between 10 and 90% by weight of (co)polyamide, such as a linear (co)polyamide, preferably from 30 to 80% by weight, with respect to the total proportion of (co)polyamide and polyamide according to the invention.

The compositions according to the invention can be used as starting material in the field of engineering plastics, for example in the preparation of articles obtained by injection molding, by injection/blow molding, by extrusion or by extrusion/blow molding.

According to a standard embodiment, the modified polyamide is extruded in the form of rods, for example in a twin-screw extrusion device, which are subsequently cut into granules. The molded components are subsequently produced by melting the granules produced above and feeding the composition, in the molten state, to injection molding devices.

Specific terms are used in the description so as to facilitate the understanding of the principle of the invention. Nevertheless, it should be understood that no limitation on theos scope of the invention is envisaged by the use of these specific terms. The term “and/or” includes the meanings and, or and also all the other possible combinations of the elements connected to this term.

Other details or advantages of the invention will become more clearly apparent in the light of the examples below, given solely by way of indication.

### EXPERIMENTAL PART

### Example 1

### Manufacture of the Polyamides

The polymerization is carried out in a heated autoclave comprising stirring means.

11.111 kg of N salt (equimolar amount of adipic acid and hexamethylenediamine), 81 g of 2,2,6,6-tetra(β-carboxyethyl)cyclohexanone (0.25 mol %), 80 g of benzoic acid (0.78 mol %) and 40 g of antifoaming agent (Silcolapse) are added to the autoclave with 5 liters of distilled water at a temperature of 90° C.

The mixture, set stirring, is heated to a temperature of 280° C. under 7.5 atmospheres. It is maintained at this temperature and pressure for 2 hours.

The pressure is subsequently reduced and then the autoclave is swept with nitrogen for one and a half hours while maintaining the temperature at 280° C. The system is subsequently placed under vacuum, at a pressure of 0.5 atmosphere, for one hour.

The molten polymer is subsequently extruded in the form of rods, then rapidly cooled with water and cut up into granules.

Various polymers are synthesized in this way by varying the proportion of the polyfunctional and monofunctional compounds.

Example C1 corresponds to a linear polyamide 66 manufactured in the absence of polyfunctional and monofunctional compound.

### Example 2

### Polyamide Properties

The characteristics, rheological properties and mechanical properties of these polymers are collated in table 1 below. Test specimens produced by injection molding are manufactured in order to measure some of the properties.

TABLE 1

| | C1 | 1 | 2 | 3 | 4 |
|---|---|---|---|---|---|
| Content of | 0 | 0.25 | 0.3 | 0.25 | 0.4 |
| polyfunctional compound | | | | | |
| (mol %) | | | | | |
| Content of | 0 | 0.78 | 0.8 | 0.6 | 0.8 |
| monofunctional | | | | | |
| compound (mol %) | | | | | |
| NH₂ | 50 | 13 | 14 | 15 | 14 |
| (meq/kg) | | | | | |
| COOH | 70 | 190 | 205 | 180 | 222 |
| (meq/kg) | | | | | |
| VI (1) | 142 | 92 | 87 | 102 | 100 |
| Melt flow index (2) | 8 | 43.2 | 42.5 | 32 | 39 |
| (g/10 min) | | | | | |
| Notched Izod impact | 5.7 | 3.7 | 3.5 | 3.9 | 3.6 |
| (kJ/m²) | | | | | |
| Unnotched Izod impact | — | 72 | 60 | 63 | 78 |
| (kJ/m²) | | | | | |
| Tensile strength | 55 | 75 | 67 | 75 | 70 |
| (N/mm²) | | | | | |
| Elongation | 30 | 2.7 | 2.7 | 3.2 | 2.7 |
| (%) | | | | | |
| Tensile modulus | 3100 | 3410 | 3110 | 3080 | 3010 |
| (N/mm²) | | | | | |

(1) Viscosity index, measured from a 0.5% solution of polymer dissolved in 90% formic acid, according to standard ISO307
(2) Melt flow index (MFI), determined according to standard ASTM D1238, measured in g/10 min at 275° C. under a load of 325 g

The contents of acid and amine end groups are quantitatively determined by potentiometry, the Izod impacts are measured according to standard ISO 179/leU and ISO 179/leA and the tensile strength, the elongation and the tensile modulus are measured according to standard ISO 527 at a temperature of 23° C.

### Example 3

### Filler-Comprising Compositions

Compositions comprising, as polyamide matrix, the polyamides manufactured above, are charged with 50% by weight of glass fibers by melt blending in a twin-screw extruder of Werner-Pfleiderer ZSK 40 type with venting (L/D=36). The glass fibers are Vetrotex 99B. The extrusion parameters are as follows: extrusion temperature with an increasing profile 235-280° C.; rotational speed of the screw: 260 revolutions per minute; throughput of the composition: 40 kg/h; the motor torque and the motor output absorbed vary according to the polyamides.

The properties of the filler-comprising compositions are collated in table 2 below. Test specimens produced by injection molding are manufactured in order to measure some of the properties.

TABLE 2

| | C1 | 1 | 2 | 3 | 4 |
|---|---|---|---|---|---|
| Melt flow index (3) | 2.8 | 16.5 | 18 | 11 | 13 |
| (g/10 min) | | | | | |
| Notched Izod | 17.8 | 18.4 | 18.8 | 17 | 18 |
| impact | | | | | |
| (kJ/m²) | | | | | |
| Unnotched Izod | 92 | 86 | 90 | 81 | 82 |
| impact | | | | | |
| (kJ/m²) | | | | | |
| Tensile force | 224 | 244 | 251 | 233 | 247 |
| (N/mm²) | | | | | |
| Elongation | 2.7 | 2.3 | 2.5 | 2.2 | 2.3 |
| (%) | | | | | |
| Tensile modulus | 15 300 | 15 100 | 16 300 | 15 400 | 16 300 |
| (N/mm²) | | | | | |
| Spiral test | 33 | 45 | 48 | 40 | 45 |
| (cm) | | | | | |
| Surface | poor | very | very | very | very |
| appearance | | good | good | good | good |
| Motor torque | 50-55 | 30-35 | 30-35 | 30-35 | 30-35 |
| (N/mm) | | | | | |
| Motor output | 26 | 16 | 16 | 17 | 16 |
| absorbed | | | | | |
| (A) | | | | | |

(3) Melt flow index (MFI), determined according to standard ASTM D1238, measured in g/10 min at 275° C. under a load of 2160 g

The surface appearance is assessed visually; the spiral test makes it possible to quantify the flowability of the compositions by melting the granules and by injecting them into a spiral-shaped mold of semi-circular cross section with a thickness of 2 mm and a diameter of 4 cm, in a BM-Biraghi 85T press at a barrel temperature of 275° C., a mold temperature of 80° C. and an injection pressure of 80 bar (the result is expressed as length of mold correctly filled with the composition).

### Example 4

### Filler-Comprising Compositions Comprising a Blend of Linear Polyamide and of Polyamide According to the Invention

Compositions comprising the polyamide of example 4 (PA 4) and various proportions of polyamide 66 (PA C1) are manufactured by melt blending in a twin-screw extruder of Werner-Pfleiderer ZSK 40 type with venting (L/D=36), in the presence of 30% by weight of glass fibers. The extrusion parameters are as follows: extrusion temperature with an increasing profile 250-285° C.; rotational speed of the screw: 260 revolutions per minute; throughput of the composition: 40 kg/h; the motor torque and the motor output absorbed vary according to polyamides.

The properties of the filler-comprising compositions are collated in table 3 below. Test specimens produced by injection molding are manufactured in order to measure some of the properties.

TABLE 3

| | 4 | 5 | 6 | 7 |
|---|---|---|---|---|
| Polyamide | 100% | 80% PA 4 + | 70% PA 4 + | 50% PA 4 + |
| composition | PA 4 | 20% PA C1 | 30% PA C1 | 50% PA C1 |
| Melt flow | 10 | 11.5 | 10 | 8.1 |
| index (3) | | | | |
| (g/10 min) | | | | |
| Notched | 11 | 10 | 11 | 11 |
| Charpy | | | | |
| impact | | | | |
| (kJ/m²) | | | | |
| Unnotched | 45 | 50 | 54 | 67 |
| Charpy | | | | |
| impact | | | | |
| (kJ/m²) | | | | |

(3) Melt flow index (MFI), determined according to standard ASTM D1238, measured in g/10 min at 275° C. under a load of 2160 g

The Charpy impact is measured according to standard ISO 179/leA.

It is observed that the addition of linear polyamide 66 to the polyamide according to the invention makes it possible to enhance the mechanical properties of the resulting composition, without negatively affecting its melt flow index.

### Example 5

### Manufacture and Properties of Modified Polyamides

Modified polyamides according to the invention are manufactured as described in example 1 according to the proportions of the monomers of test 4 and with addition of 5 or 10% by weight of caprolactam (thus replacing 5 or 10% by weight of N salt).

The molten polymer is subsequently extruded in the form of rods, then rapidly cooled in water and cut up into granules.

The characteristics, rheological properties and mechanical properties of these polymers are collated in the table below.

TABLE 4

| | C1 | 4 | 8 | 9 |
|---|---|---|---|---|
| Caprolactam | 0 | 0 | 5 | 10 |
| (% by | | | | |
| weight) | | | | |
| Melt flow | 8 | 32 | 31 | 32 |
| index (2) | | | | |
| (g/10 min) | | | | |
| Notched | 4.5 | 3.4 | 4.2 | 4.6 |
| Charpy | | | | |
| impact | | | | |
| (kJ/m²) | | | | |

(2) Melt flow index (MFI), determined according to standard ASTM D1238, measured in g/10 min at 275° C. under a load of 325 g

1. A polyamide capable of being obtained by polymerization in the presence of at least:
(i) dicarboxylic acid and diamine monomers, or their salts,
(ii) from 0.05 to 0.5 mol % of a polyfunctional compound comprising at least 3 functional groups X1, with respect to the sum of the number of moles of constituent monomers of the polyamide;
(iii) from 0.2 to 2 mol % of a monofunctional compound comprising a functional group X2, with respect to the sum of the number of moles of constituent monomers of the polyamide;
the functional groups X1 and X2 being carboxylic acid functional groups or amine functional groups capable of reacting with the dicarboxylic acid and diamine monomers (i) and of forming an amide bond;
when the polyfunctional compound (ii) comprises functional groups X1 of carboxylic acid type, the monofunctional compound (iii) comprises a functional group X2 of carboxylic acid type; and
when the polyfunctional compound (ii) comprises functional groups X1 of amine type, the monofunctional compound (iii) comprises a functional group X2 of amine type.

2. The polyamide as claimed in claim 1, wherein the constituent monomers of the polyamide of dicarboxylic acid type are aliphatic or aromatic and comprise from 4 to 12 carbon atoms.

3. The polyamide as claimed in claim 1, wherein the constituent monomers of the polyamide of diamine type are aliphatic or aromatic and comprise from 4 to 12 carbon atoms.

4. The polyamide as claimed in claim 1, wherein the constituent monomers of the polyamide are adipic acid and hexamethylenediamine, or their salts.

5. The polyamide as claimed in claim 1, wherein the polyfunctional compound (ii) is represented by the general formula (1):
R-[A-X1]ₙ (1)
wherein:
R is an aliphatic (linear or branched), cycloaliphatic or aromatic hydrocarbon radical comprising at least two carbon atoms and which can comprise one or more heteroatoms;
A is a covalent bond or an aliphatic hydrocarbon radical which can comprise one or more heteroatoms, and which comprises from 1 to 20 carbon atoms;
X1 is a carboxylic acid functional group or a primary or secondary amine functional group, or their salts; and
n is an integer of between 3 and 10.

6. The polyamide as claimed in claim 1, wherein the polyfunctional compound (ii) is an aliphatic, cycloaliphatic or aromatic hydrocarbon compound comprising at least 4 carbon atoms which can comprise one or more heteroatoms.

7. The polyamide as claimed in claim 1, wherein the polyfunctional compound (ii) carrying carboxylic acid functional groups X1 is selected from the group consisting of: 2,2,6,6-tetra(β-carboxyethyl)cyclohexanone, diaminopropane-N,N,N′,N′-tetraacetic acid, 3,5,3′,5′-biphenyltetracarboxylic acid, acids derived from phthalocyanin and naphthalocyanin, 1,3,5,7-naphthalenetetracarboxylic acid, 2,4,6-pyridinetricarboxylic acid, 3,5,3′,5′-bipyridyltetracarboxylic acid, 3,5,3′,5′-benzophenonetetracarboxylic acid, 1,3,6,8-acridinetetracarboxylic acid, trimesic acid, 1,2,4,5-benzenetetracarboxylic acid and 2,4,6-tri(aminocaproic acid)-1,3,5-triazine (TACT).

8. The polyamide as claimed in claim 1, wherein the polyfunctional compound (ii) carrying amine functional groups X2 is selected from the group consisting of: nitrilotrialkylamines, dialkylenetriamines, bishexamethylenetriamine, trialkylenetetramines and tetraalkylenepentamines, 4-aminoethyl-1,8-octanediamine, melamine, compounds originating from the reaction of trimethylolpropane or of glycerol with propylene oxide and amination of the end hydroxyl groups of general formula: 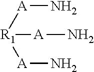
wherein: R₁ represents a propane-1,1,1-triyl or propane-1,2,3-triyl radical and A represents a polyoxyethylene radical.

9. The polyamide as claimed in claim 1, wherein the monofunctional compound (iii) is an aliphatic, cycloaliphatic or aromatic hydrocarbon compound comprising at least 2 carbon atoms and which can comprise heteroatoms.

10. The polyamide as claimed in claim 1, wherein the monofunctional compound (iii) is selected from the group consisting of: n-hexadecylamine, n-octadecylamine and n-dodecylamine, acetic acid, lauric acid, benzylamine, benzoic acid, propionic acid and 4-amino-2,2,6,6-tetramethylpiperidine.

11. The polyamide as claimed in claim 1, wherein the functional groups X1 of the polyfunctional compound (ii) and the functional group X2 of the monofunctional compound (iii) are identical.

12. The polyamide as claimed in claim 1, comprising 0.2 to 0.5 mol % of polyfunctional compounds (ii), with respect to the sum of the number of moles of constituent monomers of the polyamide.

13. The polyamide as claimed in claim 1, comprising 0.5 to 1 mol % of monofunctional compounds (iii), with respect to the sum of the number of moles of constituent monomers of the polyamide.

14. The polyamide as claimed in claim 1, wherein a proportion of polyfunctional compounds (ii) and monofunctional compounds (iii) which obeys the following relationship:
(nCpo×FX1)/nCmo of between 0.1 and 4,
wherein:
nCpo the number of moles of polyfunctional compounds (ii),
nCmo the number of moles of monofunctional compounds (iii), and
FX1 the number of functional groups X1 of the polyfunctional compound (ii).

15. The polyamide as claimed in claim 1, wherein the polymerization is carried out in the presence of an amino acid or a lactam.

16. The polyamide as claimed in claim 1, wherein the modified polyamide exhibits a viscosity in solution of between 80 and 120, according to standard ISO 307, with 0.5% of polymer in 90% of formic acid, at a temperature of 25° C.

17. A composition comprising at least the polyamide as claimed in claim 1.

18. The composition as claimed in claim 17, comprising the polyamide as the matrix.

19. The composition as claimed in claim 17, comprising a blend of a thermoplastic polymer and the polyamide.

20. The composition as claimed in claim 19, comprising a blend of a (co)polyamide and the polyamide.

21. The composition as claimed in claim 1, further comprising at least one reinforcing and/or bulking filler.

22. An article obtained by injection molding, injection/blow molding, extrusion, or extrusion/blow molding of the composition as claimed in claim 17.
